(19) United States
(12) Patent Application Publication
(10) Pub. No.: US 2020/0123824 A1
(43) Pub. Date: Apr. 23, 2020

(54) DOOR PIVOT ASSEMBLY AND SMART LOCKER USING THE SAME

(71) Applicant: Goldtek Technology Co., Ltd., New Taipei City (TW)

(72) Inventor: WU-HUNG YANG, New Taipei (TW)

(21) Appl. No.: 16/410,053

(22) Filed: May 13, 2019

(30) Foreign Application Priority Data
Oct. 18, 2018 (TW) 107136835

(51) Int. Cl. E05D 7/081; A47B 47/02; A47B 87/02

(52) U.S. Cl. CPC E05D 7/081; A47B 47/021; A47B 2220/0072; E05Y 2900/208; A47B 87/0284

(57) ABSTRACT

A door pivot assembly used for secure storage includes a bushing, a nut and a bolt. The bushing is secured to a door frame, and the bushing has a non-threaded bore therethrough. The nut is secured to a door panel, and the nut has a threaded bore therethrough. The threaded bore of the nut aligns with the non-threaded bore of the bushing. The bolt passes through the door panel and the door frame. The bolt has a head, a threaded shaft, and a non-threaded shaft. The threaded shaft and the non-threaded shaft sequentially extend from the head. The threaded shaft is screwed into the threaded bore of the nut, and the non-threaded shaft is rotatably disposed in the non-threaded bore of the bushing, so that the door panel can be pivoted relative to the door frame. A smart locker having the door pivot assembly is also provided.

### FIELD

The subject matter herein generally relates to a locker, especially relates to a door pivot assembly and a smart locker using the same.

### BACKGROUND

Lockers typically employ two types of door pivot structures, one having a spring pivot structure and the other being a hinge.

The pivot structure having a spring may include a receiving seat, a spring, a shaft cap and a rotating shaft. The receiving seat is fixed to the door panel by welding, the spring is located in the receiving seat, and the shaft cap is fixed on a door frame. The rotating shaft rotatably penetrates the door panel and the door frame. One end of the rotating shaft is located in the receiving seat and abuts against the spring, and the spring provides elastic force so that the other end of the rotating shaft protrudes from the door panel and is located in the shaft cap, so that the door panel can be pivoted relative to the door frame. However, the weld quality is may be inconsistent, poor welding resulting in a door panel prone to pivoting and forming a defective product. In addition, when assembling or disassembling the door panel, the rotating shaft is pulled so as not to protrude from the door panel, which makes disassembly and assembly inconvenient, and the spring remains compressed during the assembly or disassembly which may adversely affect the service life of the spring.

The hinge is fixed between the door panel and the door panel by welding or a plurality of screws, so that the door panel can pivot relative to the door panel. However, the weld quality is may be inconsistent, poor welding also resulting in a door panel prone to pivoting and forming a defective product. In addition, a large number of screws are needed for disassembly and assembly which may be cumbersome.

Therefore, there is room for improvement within the art.

### BRIEF DESCRIPTION OF THE DRAWINGS

Implementations of the present technology will now be described, by way of embodiments, with reference to the attached figures.

FIG. 1 is an assembled, isometric view of a smart locker according to an embodiment.

FIG. 2 is an isometric view of an assembled door pivot assembly according to an embodiment.

FIG. 3 is an isometric view of an exposed door pivot assembly according to an embodiment.

FIG. 4 is an enlarged view of circled portion IV of FIG. 3.

FIG. 5 is a cross-sectional view along line V-V of FIG. 2.

FIG. 6 is a block diagram of a control console according to an embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

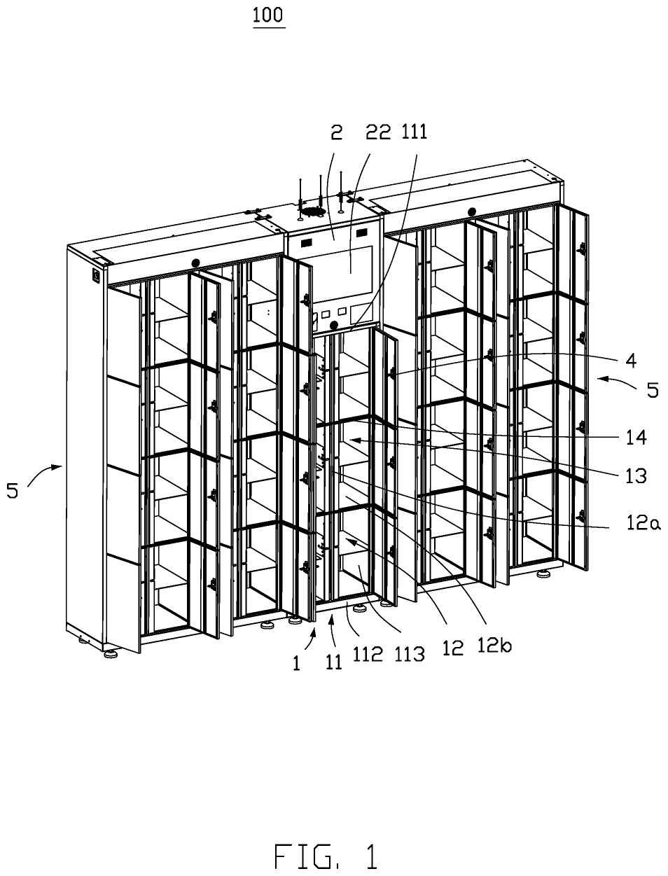

FIG. 1 shows a smart locker 100 of an embodiment. The smart locker 100 provides convenience in the secure depositing and releasing of something to a user. The smart locker 100 includes a main locker 1 and a control console 2.

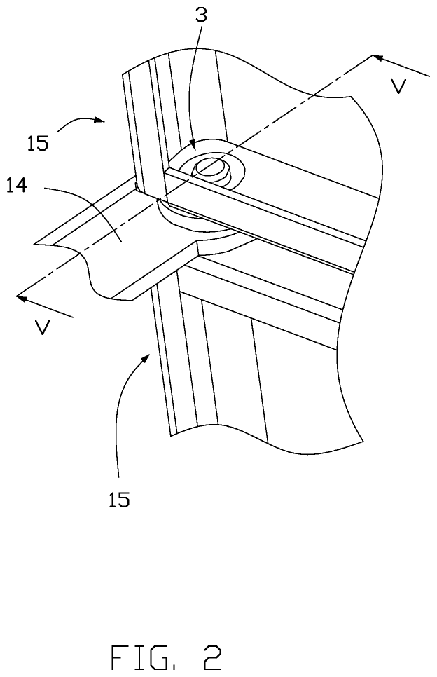

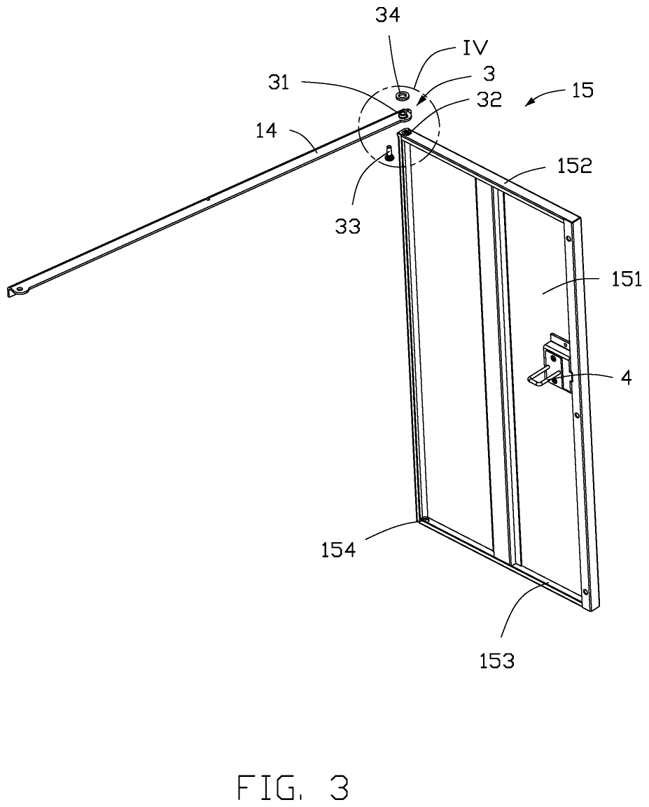

The main locker 1 includes a frame 11. A plurality of division plates 12 are provided in the frame 11 to separate the inside space of the frame 11 into a plurality of storage chambers 13. Each of the storage chambers 13 is provided with door frames 14 located at an opening of the storage chamber 13. As shown in FIG. 2 and FIG. 3, a door panel 15 is hinged on the door frames 14 via a door pivot assembly 3. The door panel 15 is provided with an electric lock 4, and the door panel 15 is locked on the door frames 14 via the lock 4.

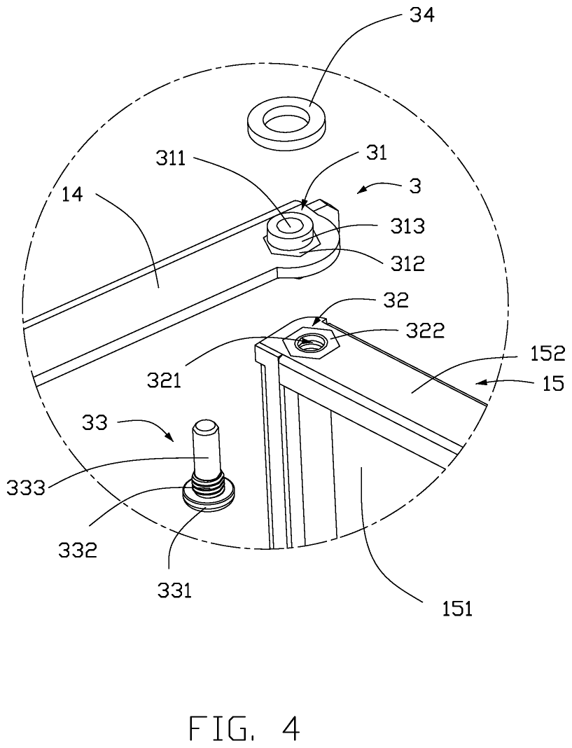

FIG. 3 and FIG. 4 show the door pivot assembly 3. The door pivot assembly 3 includes a bushing 31, a nut 32, and a bolt 33. The bushing 31 is secured to the door frame 14. The bushing 31 has a non-threaded bore 311 therethrough. The nut 32 is secured to the door panel 15. The nut 32 has a threaded bore 321 therethrough. The threaded bore 321 of the nut 32 aligns with the non-threaded bore 311 of the bushing 31. The bolt 33 passes through the door panel 15 and the door frame 14. The bolt 33 includes a head 331, a threaded shaft 332, and a non-threaded shaft 333. The threaded shaft 332 and the non-threaded shaft 333 sequentially extend from the head 331. In other words, the threaded shaft 332 extends from the head 331, and the non-threaded shaft 333 extends from the threaded shaft 332 and away from the head 331. The threaded shaft 332 is screwed into the threaded bore 321 of the nut 32. The head 331 resists against the nut 32. The non-threaded shaft 333 is rotatably disposed in the non-threaded bore 311 of the bushing 31, so that the door panel 15 can be pivoted relative to the door frame 14. The door panel 15 can be easily assembled or disassembled by screwing or unscrewing the single bolt 33 using a screwdriver.

As shown in FIG. 1, the control console 2 is installed on the frame 11 of the main locker 1. The control console 2 allows users to control the lock 4 to be on or off.

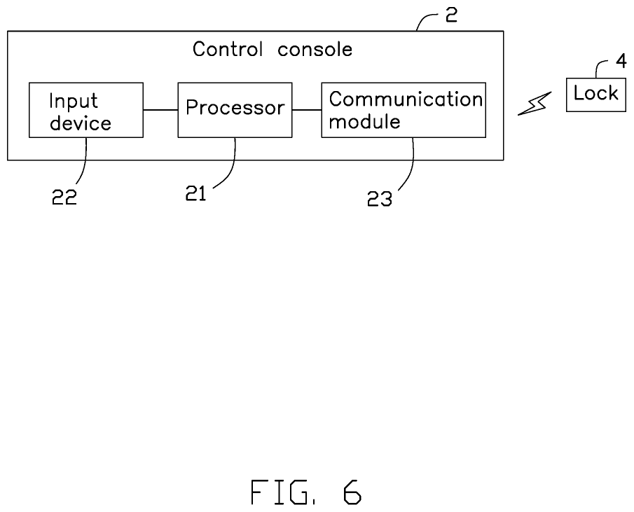

Referring to FIG. 6, the control console 2 includes a processor 21, an input device 22, and a communication module 23. The input device 22 and the communication module 23 are connected with the processor 21. The input device 22 may be a touch screen. A communication channel is provided between the communication module 23 and the lock 4.

When a user needs to deposit something, a shipping code is firstly obtained from the website of a logistics provider or from an application program (APP), and then the shipping code is input through the input device 22 of the smart locker 100. The communication module 23 transmits the unlocking signal to the lock 4, and the user can place objects for secure storage into a storage chamber 13.

When a user needs to pick up something or take something out of the secure storage, a pick-up code is firstly obtained from the website of a logistics provider or from an APP, and then the pick-up code is input through the input device 22 of the smart locker 100. The communication module 23 transmits the unlocking signal to the lock 4, and the opened door allows a user to pick up objects from the storage chamber 13.

In an embodiment, as shown in FIG. 1, the frame 11 of the main locker 1 is shaped as a cuboid. The frame 11 includes a top board 111, a bottom board 112, two side boards 113, and a rear board (not labeled). The frame 11 is provided with a plurality of vertical division plates 12a and a plurality of horizontal division plates 12b inside to define the plurality of storage chambers 13. Horizontal door frames 14 are provided at an upper edge and a lower edge of the opening of each storage chamber 13. As shown in FIG. 3, the door panel 15 includes a main body 151, an upper transom 152, and a lower transom 153. The upper transom 152 and the lower transom 153 are respectively positioned at the upper edge and the lower edge of the main body 151.

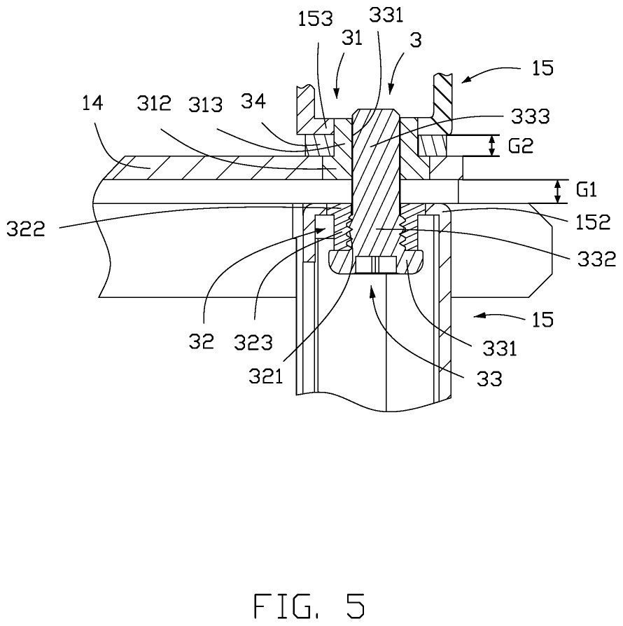

In an embodiment, as shown in FIG. 4 and FIG. 5, the bushing 31 is a pressure riveting bushing. The bushing 31 includes a bushing flange 312 and a main body 313 extending from the bushing flange 312. The bushing 31 is riveted on an end of the door frame 14 through the bushing flange 312, so that the main body 313 protrudes from a top surface of the door frame 14. The nut 32 is a pressure riveting nut. The nut 32 includes a nut flange 322 and a main body 323 extending from the nut flange 322. The nut 32 is riveted on an end of the upper transom 152 of the door panel 15 through the nut flange 322, so that the main body 323 protrudes from a bottom surface of the upper transom 152. Referring to FIG. 3, a shaft hole 154 is defined on an end of the lower transom 153 of the door panel 15. The shaft hole 154 passes through the lower transom 153. During assembly, before the bolt 33 passes through the door frame 14 and the upper transom 152 of the door panel 15, the shaft hole 154 of the lower transom 153 of the door panel 15 is sleeved on the main body 313 of another door frame 14, so that the door panel 15 is pivotally installed between two door frame 14. The door frame 14, the door panel 15, the bushing 31, the nut 32, and the bolt 33 are made of metal, giving good strength and high durability.

Referring to FIG. 5, a gap upon the door G1 is defined between the upper transom 152 of the door panel 15 and the door frame 14. The door pivot assembly 3 further includes a gasket 34. The gasket 34 is sleeved on the main body 313 and is positioned between door frame 14 and the lower transom 153 of another door panel 15, so that a gap below the door G2 is defined between the lower transom 153 of the door panel 15 and the door frame 14. The gap upon the door G1 and the gap below the door G2 are configured to allow the door panel 15 to smoothly pivot relative to the two door frames 14.

As shown in FIG. 1, the smart locker 100 of an embodiment further includes two sub lockers 5. The two sub lockers 5 are disposed on both sides of the main locker 1 to provide more storage chambers 13.

The embodiments shown and described above are only examples. Many such details are found in the relevant art. Therefore, such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A door pivot assembly comprising:
a bushing secured to a door frame and having a non-threaded bore therethrough;
a nut secured to a door panel and having a threaded bore therethrough, wherein the threaded bore aligns with the non-threaded bore of the bushing; and
a bolt passing through the door panel and the door frame and comprising a head, a threaded shaft, and a non-threaded shaft; and
wherein the threaded shaft and the non-threaded shaft sequentially extend from the head;
the threaded shaft is screwed into the threaded bore of the nut, the non-threaded shaft is rotatably disposed in the non-threaded bore of the bushing, so that the door panel is pivoted relative to the door frame.

2. The door pivot assembly of claim 1, wherein the bushing is secured to a horizontal door frame, the door panel comprises a main body, a upper transom, and a lower transom; the upper transom and the lower transom are respectively positioned at an upper edge and a lower edge of the main body of the door panel; the nut is secured to the upper transom of the door panel.

3. The door pivot assembly of claim 2, wherein the bushing comprises a bushing flange and a main body extending from the bushing flange, the bushing is riveted on an end of the door frame through the bushing flange, so that the main body of the bushing protrudes from a top surface of the door frame.

4. The door pivot assembly of claim 3, wherein the nut comprises a nut flange and a main body extending from the nut flange, the nut is riveted on an end of the upper transom of the door panel through the nut flange, so that the main body of the nut protrudes from a bottom surface of the upper transom.

5. The door pivot assembly of claim 4, wherein the head of the bolt resists against the nut.

6. The door pivot assembly of claim 5, wherein a shaft hole is defined on an end of the lower transom of the door panel, the shaft hole passes through the lower transom; the shaft hole of the lower transom is sleeved on the main body of another door frame.

7. The door pivot assembly of claim 3, wherein a gap upon the door is defined between the upper transom of the door panel and the door frame.

8. The door pivot assembly of claim 7, further comprising a gasket, wherein the gasket is sleeved on the main body and is positioned between door frame and the lower transom of another door panel.

9. The door pivot assembly of claim 8, wherein the door frame, each of the door panel, the bushing, the nut, and the bolt is made of metal.

10. A smart locker, comprising:
a locker having a frame, wherein a plurality of division plate are provided in the frame to separate an inside space of the frame into a plurality of storage chambers, each of the storage chamber is provided with door frames located at an opening of the storage chamber, a door panel is pivoted on the door frames through a door pivot assembly, and the door panel is provided with a lock; and
a control console installed on the frame of the locker; wherein the control console allows to control the lock to be on or off, the control console comprises a processor, a input device, and a communication module; the input device and the communication module are connected with the processor, and a communication channel is provided between the communication module and the lock; and
wherein the door pivot assembly comprises a bushing secured to the door frame and having a non-threaded bore therethrough, a nut secured to the door panel and having a threaded bore therethrough, and a bolt passing through the door panel and the door frame; the threaded bore aligns with the non-threaded bore of the bushing; the bolt comprises a head, a threaded shaft, and a non-threaded shaft; the threaded shaft and the non-threaded shaft sequentially extend from the head; the threaded shaft is screwed into the threaded bore of the nut, the non-threaded shaft is rotatably disposed in the non-threaded bore of the bushing, so that the door panel is pivoted relative to the door frame.

11. The smart locker of claim 10, wherein the bushing is secured to a horizontal door frame, the door panel comprises a main body, a upper transom, and a lower transom; the upper transom and the lower transom are respectively positioned at an upper edge and a lower edge of the main body of the door panel; the nut is secured to the upper transom of the door panel.

12. The smart locker of claim 11, wherein the bushing comprises a bushing flange and a main body extending from the bushing flange, the bushing is riveted on an end of the door frame through the bushing flange, so that the main body of the bushing protrudes from a top surface of the door frame.

13. The smart locker of claim 12, wherein the nut comprises a nut flange and a main body extending from the nut flange, the nut is riveted on an end of the upper transom of the door panel through the nut flange, so that the main body of the nut protrudes from a bottom surface of the upper transom.

14. The smart locker of claim 13, wherein the head of the bolt resists against the nut.

15. The smart locker of claim 14, wherein a shaft hole is defined on an end of the lower transom of the door panel, the shaft hole passes through the lower transom; the shaft hole of the lower transom is sleeved on the main body of another door frame.

16. The smart locker of claim 12, wherein a gap upon the door is defined between the upper transom of the door panel and the door frame.

17. The smart locker of claim 16, further comprising a gasket, wherein the gasket is sleeved on the main body and is positioned between door frame and the lower transom of another door panel.

18. The smart locker of claim 17, wherein each of the door frame, the door panel, the bushing, the nut, and the bolt is made of metal.
